(19) United States
(12) Patent Application Publication
(10) Pub. No.: US 2008/0061712 A1
(43) Pub. Date: Mar. 13, 2008

(54) Uniform Back-Lighting Device And Display Device Therewith

(75) Inventors: Hendrik Mattheus Bleeker, Eindhoven (NL); Hugo Cornelissen, Eindhoven (NL); Martin Jak, Eindhoven (NL); Lars Waumans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,231

(22) PCT Filed: Jul. 15, 2005
(86) PCT No.: PCT/IB05/52354

§ 371 Date: Jan. 17, 2007

(30) Foreign Application Priority Data
Jul. 21, 2004 (EP) 04103471.1

(51) Int. Cl. H05B 41/36; F21V 7/04

(52) U.S. Cl. 315/291; 362/600

(57) ABSTRACT

The present invention provides a back-lighting device, comprising a housing (10) with a plurality of fluorescent lamps (12), which are operated either individually or in groups (11A, 11B, 11C), wherein operation is controlled by a control device (1) which is fed with response signal; from one or more sensor devices (13A, 13B, 13C). The response signals relate to the intensity of the (groups) of fluorescent lamps. This allows a correction of inhomogeneities in the intensity distribution, based on group or individual variations, and thus a more homogeneous illumination. The invention also provides a display device comprising a back-lighting device according to the invention and a liquid crystal display.

The present invention relates to a back-lighting device, comprising a housing with a plurality of groups of at least one fluorescent lamp, a control device for operating said plurality of groups, at least one sensor device, said sensor device being coupled to the control device and being able to provide at least one response signal for the fluorescent lamps, said response signal depending on at least one lamp parameter.

The invention also relates to a display device with a back-lighting device according to the present invention.

U.S. Pat. No. 6,157,143 discloses a back-light assembly for an LCD, comprising at least one fluorescent lamp and a power controller to regulate lamp current, as well as a light level sensor to provide a signal to the controller to regulate the lamp current.

This known device has a disadvantage in that it sometimes offers a non-homogeneous back-lighting of the LCD, which is to be avoided. The inhomogeneity may be due to various causes, such as temperature differences in the device, which have their influence on light output, et cetera.

It is an object of the present invention to provide a back-lighting device which is able to deliver a more homogeneous back-lighting.

This object is achieved with a back-lighting device according to the invention, comprising the device of the kind mentioned in the introduction, wherein the sensor device is able to provide at least one response signal for each of the groups of fluorescent lamps, said response signal depending on at least one lamp parameter of said group, and wherein operation of each group of said plurality of groups is controllable by the control device in dependence of the response signal that relates to said group.

By dividing the fluorescent lamps in relevant groups, it is possible to determine for each of the groups a lamp parameter, notably a lamp parameter that relates to the intensity, on the basis of which operation of the group of lamps may be adjusted. It is thus possible to adjust the intensity of one group of fluorescent lamps with respect to e.g. some preset value. In this way, it is possible to take into account changing temperatures inside the device, e.g. due to convection, as well as different lamp degradation as a function of time, differences in characteristics of the lamps and lamp drivers etc. The adjustment may be performed automatically, by the control device, or by some operator. For example, if it is determined that a group of fluorescent lamps shows a decreased intensity, based on measurement of a lamp parameter, operation of said group may be adjusted, such as by changing the supplied lamp current, until the parameter corresponds to the preset value. In this context and throughout the text, “fluorescent lamp” is sometimes simply shortened to “lamp”.

The distribution or division of the fluorescent lamps over the various groups will be discussed separately below.

Moreover, it is also possible to set the back-lighting to different levels for different parts of the device, e.g. a darker part for less important information.

In a special embodiment, the operation of each group of said plurality of groups is controllable by the control device in dependence on all response signals for each of said groups. This means that operation of each group of fluorescent lamps may be made dependent of not only a preset value, but also, or alternatively, a value as measured at another group. This offers more flexibility in operating the groups of fluorescent lamps. E.g., in a case where the temperature of the environment is so low that no single lamp of the device is able to operate at its optimum temperature within the possibilities of the control device (lamp current limit), the control device or operator may still be able to determine what intensity may be achieved with the weakest or darkest group of lamps, and adjust the operating conditions of the other, brighter groups of lamps to that lowest intensity value.

This relates to a method of operating the back-lighting device according to the invention: operating each group of fluorescent lamps, measuring a lamp parameter of each group, notably a lamp parameter relating to an intensity of a group of fluorescent lamps, preferably of each fluorescent lamp, adjusting the operation of each group, either to a preset operational value or to an operational value determined on the basis of all measured parameters. This latter possibility relates to the case wherein e.g. no preset operational value is given, or one or more (groups of) fluorescent lamps would have to be operated in a range of operational values that is not within the possibilities of either the control device or the (group of) fluorescent lamps.

In an advantageous embodiment, the sensor device comprises a plurality of group sensors, there being provided at least one group sensor for each group of the plurality of groups of fluorescent lamps, wherein the each group sensor is coupled to the control device and is able to provide at least one response signal for said group, said response signal depending on at least one lamp parameter of said group. This is a specific embodiment, in which the sensor device is distributed over a number of physically separate sensors, called group sensors, that are each able and constructed to provide a response signal for the group they are associated with. This offers the possibility to measure each group simultaneously, without the need for some construction for the (general) sensor device in order to be able to measure each group.

In another advantageous embodiment, the sensor device is switchable between at least two different positions, in each of which positions the sensor device is able to determine the response signal for the group corresponding to that position. Preferably, the number of different positions for the sensor device corresponds to the number of groups to be measured. In this case, there need be provided only one physical sensor, with the possibility of selecting a group to be measured, i.e. a parameter thereof. Thereto, the sensor device should be switchable, which is to be construed as encompassing not only switchable mechanically or electronically, but also movable e.g. along the groups of lamps, rotatable, etc.

In a special embodiment of the back-lighting device according to the invention, each group comprises only one fluorescent lamp. In this embodiment, every individual fluorescent lamp is measured, which ensures optimum homogeneity of the radiation, but also optimum flexibility with respect to lighting schemes of the back-lighting device. For example, it is now possible to provide various zones with different intensity, should this be desired. It is remarked here that is not necessary to have only one fluorescent lamp per group. Any other number is also possible, such as two, three etc. A number greater than one may e.g. be advantageous for a symmetric back-lighting device, in which it may be expected that temperature differences are also symmetric and have thus a similar effect on the respective individual lamps. In this case the two (or four, etc.) outermost lamps may form a first group, a second group is formed by the inner neighbor of each of the two outermost lamps, etc. Other subdivisions, such as a first group comprising one half of the total number of lamps, e.g. in the upper or right half of the back-lighting device, and a second group comprising the remaining lamps, are also possible. An advantage of groups with more than one lamp is a lower number of sensors and measurements. Measurements of lamp parameter(s) of a lamp in a group of lamps may be considered a sampling, and may preferably be used if a relationship between the sampled lamp and the other lamps in the group is known.

Advantageously, the lamp parameter comprises an intensity, of or relating to the lamps or lamp group, and the sensor device comprises an optical sensor. Since measurement intensity is of most direct interest, measuring intensity is a preferred embodiment, and may be preferably carried out by an intensity sensor. Such intensity sensor may be provided for each individual lamp, or for a every group containing more than one lamp each, in which case it is an average intensity which is determined for each group. The intensity sensor may be positioned at any desired location, such as directly on a lamp, preferably on a side facing away from a light emitting side of the back-lighting device, or any other location suitable for measuring the intensity of the relevant lamp or group of lamps.

In an advantageous embodiment, the lamp parameter comprises a temperature of a lamp envelope of a fluorescent lamp, and the sensor device comprises a temperature sensor. It is not necessary to measure lamp (or lamp group) intensity directly, since the intensity may also be inferred from the temperature of the lamp envelope. A mercury discharge lamp has an optimum output around a certain (lowest) temperature which is roughly between 35-75° C., dependent on lamp parameters such as diameter of the envelope. The relationship between lamp temperature and intensity is known for various types of lamps, and may thus be inferred from a measured temperature of the lamp. If desired, e.g. for even more precision, a gauge measurement may be carried out for each lamp. Furthermore, if lamp temperature various only slightly, or according to a known pattern, in the back-lighting device, it is possible to measure the temperature of only one lamp or a few lamps of each group, as a kind of sample. On the basis of the measured temperature, the intensity of each lamp or group of lamps may be determined, and the operation of the lamps or groups of lamps may be adjusted accordingly, e.g. through adjusting the lamp current, or through adjusting the duty cycle of the relevant (group(s) of) lamps, i.e. by changing the on/off time ratio. It is noted that the above holds in particular for lamp operation with constant (and known) lamp current. If lamp current may vary, for example because of adjusted lamp operation, it may be preferable to include a lamp current measurement, e.g. through a lamp current sensor, which may be built into the power control unit. This variability is not present in the case where lamp operation is adjusted through changing the duty cycle, where lamp current is always known (either zero or maximum and known value).

Note that it is possible to use both types of sensors in one device, and if desired at the same time, as well as any other type of suitable sensor. This may further increase the accuracy of the operation of the (groups of) lamps in the back-lighting device, as it may now be based on more than one parameter.

Preferably, the lamp parameter comprises the lowest temperature of the lamp envelope. In fact it is the lowest temperature of the envelope of the fluorescent lamp which determines the output of the lamp, so it is preferable to determine this lowest temperature as this is a very reliable quantity. In many cases it is the temperature at or near a lamp base which is the lowest temperature. However, e.g. forced air cooling may cause a shift of this position e.g. toward the middle of the lamp envelope. Moreover, in case of applications such as backlighting, the positioning of the lamp electrodes and/or the power input may be such that the lamp bases get relatively hotter, and the coldest spot is no longer located at a lamp base. It is, however, not necessary to determine the lowest temperature, as long as this lowest temperature is determinable from the actually measured temperature. In other words, the measured temperature should have a known relationship to the lowest temperature of the lamp envelope. This may for example be established through a gauge measurement of the temperature distribution of the lamp. An advantage of measuring temperature, and in particular the lowest envelope temperature, even more particular if this lowest temperature is located at or near a lamp base, is that in that case the sensor is located in a position that is the least disturbing with respect to the emitted radiation.

In an alternative or additional embodiment, the lamp parameter comprises a lamp current and/or a lamp voltage. For most fluorescent lamps, the relationship between lamp voltage, lamp current and (lowest) lamp temperature is known. Hence the lamp temperature may be determined as soon as lamp voltage and lamp current are known. On the basis of the thus determined lamp temperature and measured lamp current, the light output or intensity may be determined, because that is also a known function of the parameters lamp temperature and lamp current, as discussed above.

In a special embodiment, the sensor device comprises a lamp voltage sensor. Lamp current may for example be fixedly set in the power control unit, e.g. through setting of a current source. It is then only required to measure lamp voltage by means of a lamp voltage sensor in order to know both required values.

Alternatively or additionally, the sensor device comprises a lamp current sensor. This may be useful in the case where the current source is variable, and lamp current should be measured, or if for some reason the power source comprises a voltage source, providing itself a known lamp voltage. Note that this latter possibility is of very limited usefulness in cases where the lamp requires a ballast (the usual case).

In another special embodiment, the lamp parameter comprises a lamp current and lamp voltage, wherein the control device comprises a pulsable current source, i.e. switchable or pulsed, and wherein the sensor device comprises a voltage sensor. This offers a way of measuring lamp voltage that does not disturb normal lamp operation. Thereto, the lamp is operated with a known or measured lamp current, which is very much lower than the usual lamp current, e.g. only 1% of the normal lamp current, or even less, say 1 mA or a few mA. This is preferably performed for a time period which is very short compared to a normal cycle (e.g. one period of the alternating current), say 1 ms, or a few ms. If the lamp voltage is measured during this supplying of a very low lamp current, still the lamp temperature may be determined.

The back-lighting device according to the invention may be operated by an operating person, who evaluates the measured one or more parameters, in order to adjust operation of the groups of lamps, if necessary. This may be based on tables etc. Operation of the groups of lamps may also be automated, for which automation suitable circuitry may be built into the control device.

In a special embodiment of the back-lighting device according to the invention, the control device comprises an information retrieval means that is constructed to provide information for operating at least one, and preferably each, of the groups of fluorescent lamps upon being fed with a response signal. Such information retrieval means may comprise a look-up table, or any other means that provides the required information to the control device. The control device may preferably comprise an integrated circuit or (micro)computer for processing the measured response signals which are input into the circuit or computer. The look-up table may thus comprise a diskette, ROM memory, etc., or may be dynamic memory, which may be refreshed by an operating person.

In an advantageous embodiment, the back-lighting device further comprises a diffuser positioned on one side of all the fluorescent lamps, i.e. such that it is illuminated from one side only by all fluorescent lamps in the back-lighting device. Since the back-lighting device according to the present invention offers improved homogeneity of the illumination, said illumination requires less additional diffusion, if any. This allows the use of either no diffuser at all, or at least of a diffuser with a decreased diffusion level, and thus with an increased transmission. This means that in all cases, a higher net intensity is possible, since either no diffuser is necessary, or a diffuser with a higher transmission may be used.

The invention also provides a display device comprising a liquid crystal display and a back-lighting device according to the invention. Such a display device features an increased homogeneity of the illumination, and also an increased flexibility of the illumination, as compared to the known devices.

Preferably, the display device comprises a back-lighting device with a diffuser positioned between the back-lighting device and the liquid crystal display. As mentioned above, this offers an increased net intensity for the display, as compared with known display devices.

The invention will now be elucidated in further detail, with reference to the drawings that show exemplary embodiments, and in which:

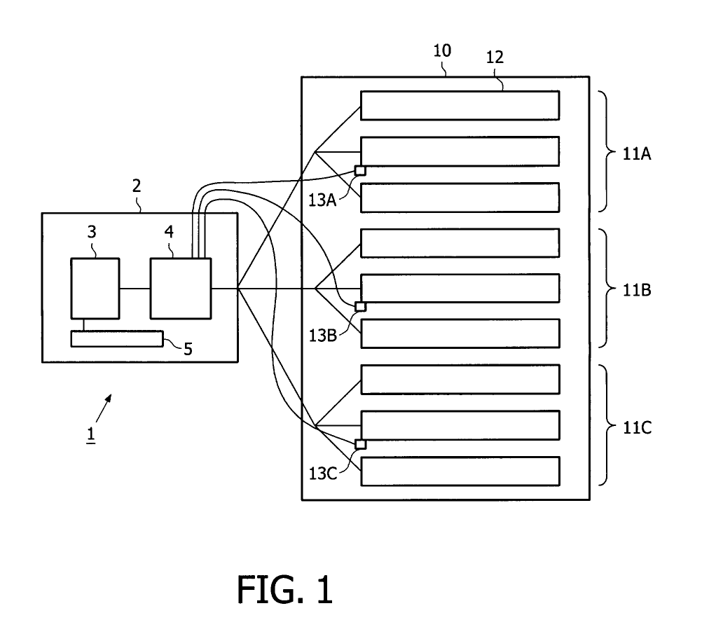

FIG. 1 diagrammatically shows a back-lighting device according to the invention;

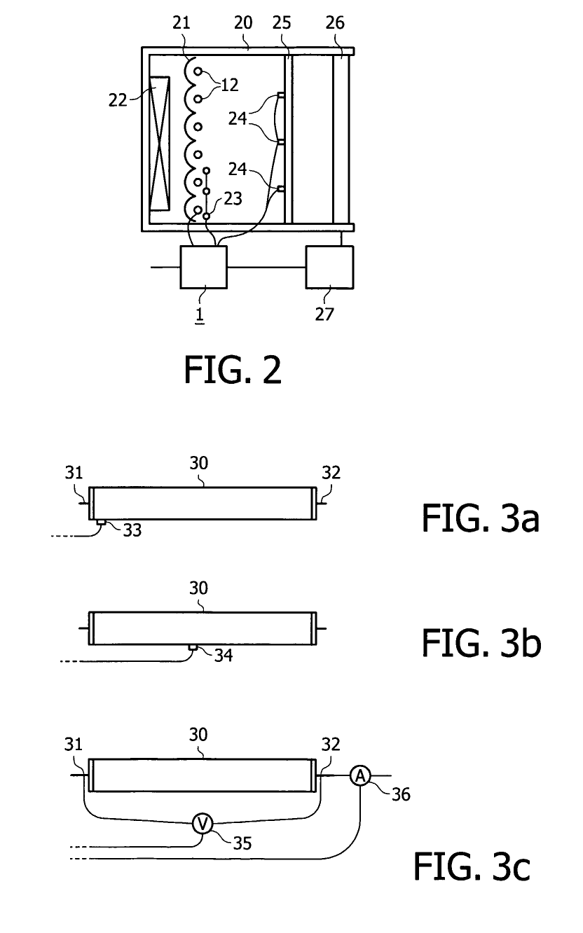

FIG. 2 diagrammatically shows a backlit LCD display device according to the invention;

FIG. 3a through 3c diagrammatically show three different sensor arrangements for a device according to the invention; and

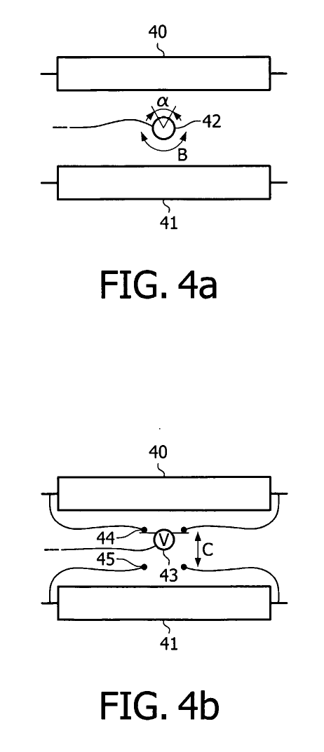

FIGS. 4a and 4b diagrammatically show two different group sensor arrangements for a device according to the invention.

In FIG. 1, there is diagrammatically shown a back-lighting device according to the invention. Herein, a control device is generally denoted 1, and comprises an optional housing 2, a power unit 3 and a power control unit 4. An information retrieval device is denoted with 5.

A light generating device, or lighting device proper, comprises a lamp housing 10, and three groups 11A through 11C of three fluorescent lamps 12 each. Each group comprises one group sensor, 13A through 13C, respectively.

The control device 1 comprises a power unit 3, which may be any device suitable for operating the lamps used in the lighting device proper, such as batteries with an optional transformer, a generator or simply a connector to mains power. The power unit 3 is connected to a power control unit 4, which controls the power actually delivered to the lamps 12 of the lighting device proper. The power unit 3 may for example be a simple potentiometer or other device for manually adjusting the delivered power, based on a measurement by a sensor. However, it will often comprise circuitry such as a printed circuit board or one or more ICs for automated control of the supplied power. The power control will often regulate the current supplied to the lamps, although in some cases a voltage or combination of voltage and current will be controlled. The power control unit 4 receives measured information, on which the control is to be based, from one or more sensors, which will be discussed hereinbelow. This measured information is processed by the control device, which may comprise a (micro)computer or other suitable circuitry, and may be compared or related to stored information in the information retrieval system 5. The latter may be a look-up table, such as on a memory chip, a CD, a diskette, or in dynamic memory etc. The stored information may e.g. comprise known data on measured relationships between various lamp parameters, such as intensity as a function of lamp current and lamp voltage, or lamp temperature, etc.

The lighting device proper comprises a lamp housing 10. This lamp housing 10 may comprise just a holder or similar structure for holding the lamps in a fixed position with respect to each other, or e.g. a box which is closed on all sides, except a light emitting side, which may alternatively be closed but optically transparent. The lamp housing 10 may be made of any suitable material or combination of materials, such as metal, plastics, glass etc.

The lighting device as shown in FIG. 1 comprises three groups 11A, 11B, and 11C of three fluorescent lamps 12 each. It goes without saying that any other desired number above one of groups of fluorescent lamps, each having at least one lamp, is suitable as well. For example, two groups of one lamp each are encompassed just the same as, say, ten groups of two, three, four etc. lamps each.

It is to be noted that the number of groups as well as the total number of lamps is at least two, and the subdivision of all the lamps present in the device into groups of lamps is based on the idea of controlling the operation of at least one lamp with respect to the operation of at least one other lamp, based on measurements via one or more sensors. Hence it is always possible to indicate two or more groups in the device, without any requirement of there being a specific physical separation between the groups. However, since lamp control of each group should be possible separately, it will be possible to characterize the groups based on the control circuitry and the distribution of the lamps over the various branches of the operation control circuit.

Note furthermore that the distribution of lamps over the groups is not limited to neighboring lamps. It is likewise possible, and sometimes preferable, to combine the lamps in a symmetrical fashion, such as the two outermost lamps in one group, the two inner neighbors thereof in a second group, etc. If the whole device is symmetrical, then at least with respect to some parameters, such as temperature inside the lamp housing 10, a symmetrical behavior may be expected. This subsequently allows a simpler design, since only half the number of sensors to measure that symmetrical parameter is needed.

The fluorescent lamps 12 may be any type of fluorescent lamp containing mercury, such as hot cathode fluorescent lamps, cold cathode fluorescent lamps, or even cathodeless fluorescent lamps which are powered through electromagnetic fields. Any desired length, power or lamp color is allowed. Even simple UVC lamps, that do not contain a fluorescent pigment and hence are not fluorescent lamps in a literal sense, may be applied in the device according to the invention.

In FIG. 1, there is shown one group sensor 13 per group, viz. 13A, 13B, and 13C, respectively. These group sensors 13 are used to obtain information (a measurement) of at least one parameter relating to the intensity of the corresponding group of lamps. Group sensors 13 may be e.g. a temperature sensor or optical sensor. Group sensor may be constructed to measure the relevant parameter as an average for the lamps in its group, or may be constructed as a sensor that may selectively measure the relevant parameter for an individual lamp in its group. The latter possibility will be discussed in connection with FIG. 4.

The group sensors 13 are connected to the control device 1, and to the power control unit 4 in particular, which may thus control and adjust the power supplied to the lamps or groups of lamps, based on a measurement signal supplied by the group sensors. Note that instead of a group sensor 13, it is also possible to use one or more sensor devices that are able to selectively supply a signal indicative for individual lamp intensity, e.g. by providing a movable sensor device. Alternatively, it is possible to provide each individual lamp with one or more sensors that are fixedly disposed therewith.

It is moreover possible to supply more than one sensor per group of lamps or even per individual lamp. This may comprise more than one sensor of the same type, such as an optical sensor. In this way, an even more reliable measurement may be made, since not only is there a back-up possibility in case one sensor is malfunctioning, but it is also possible to average the measurements of the sensors. Furthermore it is possible to provide more than one type of sensor, such as a temperature sensor and an optical sensor, or a voltage meter and a current meter.

FIG. 2 diagrammatically shows a backlit LCD display device according to the invention. Here, as in all the drawings, similar parts are denoted with the same reference numerals.

A display housing 20 contains lamps 12, behind which a reflector 21 is disposed. An optional fan 22 controls the internal environment inside the display housing 20.

First sensors 23 and second sensors 24 provide measurements of the intensity of the lamps, the sensors and the lamps being connected to a control device 1.

A diffuser 25 diffuses the light emitted by the lamps, that will back-light a liquid crystal display (LCD) 26, which is controlled by a LCD control device 27.

The display housing 20 may again be made of any suitable material, and may for example be a display device for a computer, a television set, etc.

In this case 6 fluorescent lamps are provided, which number may, however, be any natural number larger than 1. The lamps 12 are provided in front of a reflector 21, to concentrate the emitted light in a forward direction, towards the LCD 26. It is also possible to use lamps 12 with a built-in reflector. In that case, no reflector 21 is needed. Note that a lamp housing is not shown in any detail.

First sensors 23 and second sensors 24, in each case only three of which are shown, are provided to measure a parameter that relates to the intensity, e.g. intensity itself, or temperature of a lamp envelope. First sensors 23 may provide individualized measurements for each lamp, while second sensors 24 may provide measurements that relate to e.g. an intensity which is averaged over a group of lamps.

The second sensors 24 are shown provided against a diffuser 25, which diffuses the light before it reaches an LCD 26. It is only at the level of the LCD where the light should be optimally diffused, e.g. diffuse within 0.1% over 1 cm, or any other desired criterion. The light provided serves as a back-light for the LCD, and by blocking unwanted radiation, an image is formed.

The LCD itself is controlled by a LCD control unit 27, which may optionally be connected to the control device 1. This may e.g. be useful in that the measurements by the sensors 23 and 24 provide information on the color temperature of the light of the lamps, which is a.o. temperature dependent. Based on this information, the LCD control unit 27 may adjust the control of the LCD, in order to correct for any shift in color temperature. Moreover, the speed of the LCD may also depend on temperature, which may be one of the parameters measured by the sensors. Based on this information, the control speed of the LCD may be adjusted.

In this case, the control device 1 and the LCD control device 27 are shown to be separate from the display housing 20. It is also possible to integrate one or both of the devices 1 and 27 into the display housing.

FIG. 3a through 3c diagrammatically show three different sensor arrangements for a device according to the invention.

FIG. 3a shows a fluorescent lamp with a lamp envelope 30, a first connector or lamp base 31, and a second connector or lamp base 32. A temperature sensor is denoted with reference numeral 33.

In use, the lamp bases 31 and 32 are connected to power lines. Note that in these and the following Figures, the lamp bases are shown with only pin each, as is the case for e.g. cold cathode fluorescent lamps. In the case of hot cathode fluorescent lamps, each lamp base would have two pins, which are connected to a filament electrode, and which would carry heater current for heating the filament electrode. Since this is irrelevant for the present invention, the drawings only show one pin, without the invention being limited thereto. Note that a side elevation view of a double-pin lamp base would also show only one pin.

The temperature sensor 33 is disposed in good thermal contact with the lamp envelope 30, and connected to a control device (not shown). The sensor is disposed at a position where the temperature of the envelope is lowest. This temperate determines the mercury vapor pressure, which in turn determines the light output/luminous efficacy. Since the light output as a function of coldest-spot temperature is known in the art, and may be determined on a lamp-to-lamp basis for even more precision, such a temperature measurement may suffice to determine the light output, and thus to provide a signal with which to correct deviations from one lamp to another.

In almost all cases, the coldest spot will be very near a lamp base of the fluorescent lamp, as shown. More particular, in the case where the electrode stems of the lamp are different, it is the long stem end of the envelope which has the lowest temperature. However, in some cases, such as with internal convection forced ventilation, reduced power input etc., as discussed above, the coldest spot may be located differently, and some gauge measurement may be required. In particular for the last two cases, the invention provides advantages, in that otherwise these cooling air currents might cool the lamp envelope to a different lowest temperatures, such that an inhomogeneous back-lighting arises. By determining the light output through measuring the temperature or other parameter, this effect may be corrected by increasing the power supplied to the lamp.

FIG. 3b shows a fluorescent lamp with a lamp envelope 30 and an optical sensor 34. Optical sensor 34 measures directly the optical intensity of the lamp. Thereto the sensor 34 is connected to the control device (not shown here) and may be provided in a position where it will hardly or not at all throw a visible shadow, e.g. at the back of the lamp, as seen from the direction of the LCD. Note that the sensor need not be at a position of maximum intensity, as long as the maximum intensity can be calculated form the measurement. In that way, measurements from different sensors may be compared. If desired, more than one optical sensor may be provided, to determine an average light output value for the lamp.

FIG. 3c shows a lamp envelope 30, with first and second lamp bases 31 and 32, respectively, across which a voltage meter 35 is connected. A current meter 36 is connected in series with the lamp. Both meters 35 and 36 are connected to the control device (not shown).

In use, the voltage meter 35 measures the lamp voltage, and the current meter 36 measures the lamp current. In case the lamps are operated with a preset lamp current or lamp voltage, the corresponding meter may of course be dispensed with, because the relevant value is already known. For fluorescent lamps, the relationship of the lamp voltage V, the lamp current I and the envelope temperature T are known, or may be determined on a lamp-to-lamp basis for even more accuracy. It is also possible to actively measure the lamp voltage when the lamp is “off” or in a low power state, e.g. between power pulses, at a lamp current of 1 mA, or a few mA. This does not disturb normal lamp operation.

With the measured values, a look-up table or the like may be employed by the control unit or a lamp operator to determine the light output of the lamps, and adjust lamp power through adjusting the current I, if necessary.

Other known devices to determine the light output may also be contemplated, as long as they provide information, on the basis of which the operation of the relevant lamps may be controlled.

FIGS. 4a and 4b diagrammatically show two different sensor device arrangements for a device according to the invention.

Herein, 40 denotes a first fluorescent lamp, and 41 denotes a second fluorescent lamp. A movable optical sensor device is denoted with 42 and has a viewing window that subtends a solid angle a. The sensor device 42 is connected to the control device (not shown).

The movable sensor device 42 is rotatable around some axis, in the direction of arrow B, such that, in a first position, the sensor device 42 is able to measure the intensity of the first lamp 40, and in a second position, the intensity of the second lamp 41. Due to the viewing window of the sensor device 42, the measurements are substantially independent, and do not influence each other.

The sensor device 42 is a first example of a single sensor that is able to provide measurements for each group of lamps. In this case there are two groups of one lamp each. Of course, any other number of lamps or groups could be provided as well, as long as the movable sensor device is able to measure the desired lamps, e.g. through correspondingly narrowing the viewing window or otherwise.

FIG. 4b shows an alternative sensor device arrangement. Herein, 40 and 41 denote a first and second fluorescent lamp, respectively. A movable voltmeter 43 is connectable to first connections 44 across first lamp 40, and to second connections 45 across second lamp 41, by moving in the direction of arrow C. The movable voltmeter 43 is connected to the control device (not shown).

The movable voltmeter 43 is a sensor device that is able to measure more than one lamp (group). The number of measurable lamps or groups of lamps may be increased by suitably providing the connections therefore. Instead of providing a movable voltmeter, it is of course also possible to provide suitable circuitry to connect the voltmeter to the relevant connections with the lamps which should be measured.

1. Back-lighting device, comprising
a housing (10) with a plurality of groups (11A, 11B, 11C) of at least one fluorescent lamp (12; 40, 41),
a control device (1) for operating said plurality of groups,
at least one sensor device (13A, 13B, 13C; 23, 24; 33; 34; 35, 36; 42; 43), said sensor device being coupled to the control device (1) and being able to provide at least one response signal for each of the groups of fluorescent lamps, said response signal depending on at least one lamp parameter of said group,
wherein operation of each group of said plurality of groups (11A, 11B, 11C) is controllable by the control device (1) in dependence of the response signal that relates to said group.

2. Back-lighting device according to claim 1, wherein the operation of each group (11A, 11B, 11C) of said plurality of groups is controllable by the control device (1) in dependence of all response signals for each of said groups.

3. Back-lighting device according to claim 1, wherein the sensor device comprises a plurality of group sensors (13A, 13B, 13C; 24; 42; 43), there being provided at least one group sensor for each group (11A, 11B, 11C) of the plurality of groups of fluorescent lamps, wherein each group sensor is coupled to the control device (1) and is able to provide at least one response signal for said group, said response signal depending on at least one lamp parameter of said group.

4. Back-lighting device according to claim 1, wherein the sensor device (42; 43) is switchable between at least two different positions, in each of which positions the sensor device is able to determine the response signal for the group (40, 41) corresponding to that position.

5. Back-lighting device according to claim 1, wherein each group comprises only one fluorescent lamp (12; 40, 41).

6. Back-lighting device according to claim 1, wherein the lamp parameter comprises an intensity, and wherein the sensor device comprises an optical sensor (23, 24; 34; 42).

7. Back-lighting device according to claim 1, wherein the lamp parameter comprises a temperature of a lamp envelope (30) of a fluorescent lamp, and wherein the sensor device comprises a temperature sensor (33).

8. Back-lighting device according to claim 7, wherein the lamp parameter comprises the lowest temperature of the lamp envelope (30).

9. Back-lighting device according to claim 1, wherein the lamp parameter comprises a lamp current and/or a lamp voltage.

10. Back-lighting device according to claim 9, wherein the sensor device comprises a lamp voltage sensor (35; 43).

11. Back-lighting device according to claim 9, wherein the sensor device comprises a lamp current sensor (36).

12. Back-lighting device according to claim 9, wherein the lamp parameter comprises a lamp current and a lamp voltage, wherein the control device (1) comprises a pulsable current source, and wherein the sensor device comprises a voltage sensor (35; 43).

13. Back-lighting device according to claim 1, wherein the control device (1) comprises an information retrieval means (5) that is constructed to provide information for operating at least one of the groups (11A, 11B, 11C) of fluorescent lamps (12) upon being fed with a response signal.

14. Back-lighting, further comprising a diffuser (25) positioned on one side of all the fluorescent lamps (12).

15. Display device comprising a liquid crystal display (26) and a back-lighting device according to claim 1.
